(19) United States
(12) Patent Application Publication
(10) Pub. No.: US 2002/0070955 A1
(43) Pub. Date: Jun. 13, 2002

(54) Method and system for providing accompanying explanation for a disabled action in a graphic user interface

(75) Inventors: Molly K. Barksdale, Austin, TX (US); Karalee B. Leblanc, Austin, TX (US)

Correspondence Address: Frank C. Nicholas, CARDINAL LAW GROUP, Suite 2000, 1603 Orrington Avenue, Evanston, IL, 60201, US

(73) Assignee: International Business Machines Corporation

(21) Appl. No.: 09/732,251

(22) Filed: Dec. 7, 2000

(51) Int. Cl. G09G 5/00

(52) U.S. Cl. 345/708

(57) ABSTRACT

A method for providing explanatory text in a graphic user interface is provided. An action is selected to be included in the graphic user interface. It is determined if the action is in a disabled state and explanatory text is provided in the graphic user interface for the action in the disabled state.

### BACKGROUND OF THE INVENTION

Typically, users of an operating system such as AIX™ or Microsoft Windows™ communicate their commands to a computer using a combination of actions. For example, a user may indicate a given action by selecting an object in a graphic user interface. In some systems, the graphic user interface takes the form of a “window” or drop down menu. The action(s) that may be taken appear in the window or menu. The user may then select an action, for example, by clicking on the desired action with a mouse. In some systems, if an action is not currently available, the option will appear in a “grayed out” manner or in a format that differs from the format of an action that is available. Typically this “grayed out” format indicates that the object selected is not in a state to handle all the actions that can normally be applied to it. If an action cannot be run off the selected object in a particular state, the graphic user interface associated with the action would end in error. However, there is currently no way to indicate to the user the reasons why the particular action is currently unavailable. For example, if the action were unavailable because taking it would end in error, it would be desirable to provide a user with an explanation to this effect.

It would be desirable therefore to provide a graphic user interface that overcomes the above.

### FIELD OF THE INVENTION

The invention relates to graphic user interfaces. In particular, this invention relates to methods and systems of providing an explanatory text to accompany disabled actions in a graphic user interface.

### SUMMARY OF THE INVENTION

One aspect of the present invention provides a method for providing explanatory text in a graphic user interface. An action is selected to be included in the graphic user interface. It is determined if the action is in a disabled state and explanatory text is provided in the graphic user interface for the action in the disabled state. The action may be disabled. A plurality of action may be gathered. It may be determined if the action is in an enabled state and explanatory text may be provided in the graphic user interface for the action in an enabled state. The action may also be enabled. The explanatory text may be generated and may explain why the action is in the disabled state.

Another aspect of the present invention provides a method for providing explanatory text to a user. A plurality of actions is gathered and an action is selected from them. The enablement state of the selected action is determined and explanatory text is provided to the user based on the enablement state. It may also be determined if the action implements an interface. If the action does not implement the interface, the action may be enabled and it may be indicated to the user that the evaluated action is enabled. If the action does implement the interface or provides a separate object to implement the interface, the action may be disabled and it may be indicated to the user that the action is disabled.

A subsequent action may be selected, its enablement state determined and explanatory text provided to the user based on the enablement state of the subsequent action. An enablement list of actions and corresponding enablement states may also be provided and an action evaluated by comparing it to the enablement list.

Another aspect of the present invention provides computer program product in a computer usable medium for providing explanatory text to a user. The program may include computer program code that gathers a plurality of actions, computer program code that selects an evaluated action from the plurality of actions, computer program code that determines an enablement state of the evaluated action and computer program code that provides explanatory text to the user based on the enablement state of the evaluated action.

The program may also include computer program code that determines if the evaluated action implements an interface. The program may also include computer program code that disables the evaluated action and computer program code that indicates to the user that the evaluated action is disabled.

The program may also include computer program code that selects a subsequent action from the plurality of actions, computer program code that determines an enablement state of the subsequent action and computer program code that provides explanatory text to the user based on the enablement state of the subsequent action.

The program may also include computer program code that provides an enablement list of actions and corresponding enablement states and computer program code that compares the evaluated action to the enablement list. The program may also include computer program code that creates the explanatory text.

Another aspect of the present invention provides a system for outputting information to a user. The system includes a first output interface wherein the first output interface includes at least one disabled option that may be indicated by a user; and a second output interface wherein the second output interface appears when the disabled option is indicated by the user. The second output interface may be a graphic user interface including text that explains why the disabled option is disabled.

The foregoing, and other, features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is an illustrative diagram of one embodiment of a graphic user interface showing explanatory text accompanying a disabled action in accordance with the present invention;

FIG. 2 is a flow diagram of one embodiment of a routine for providing explanatory text to accompany a disabled action in a graphic user interface in accordance with the present invention; and

FIG. 3 is a block diagram of one embodiment of a system for providing explanatory text to accompany a disabled action in a graphic user interface in accordance with the present invention.

### DETAILED DESCRIPTION OF THE PRESENTLY PREFERRED EMBODIMENTS

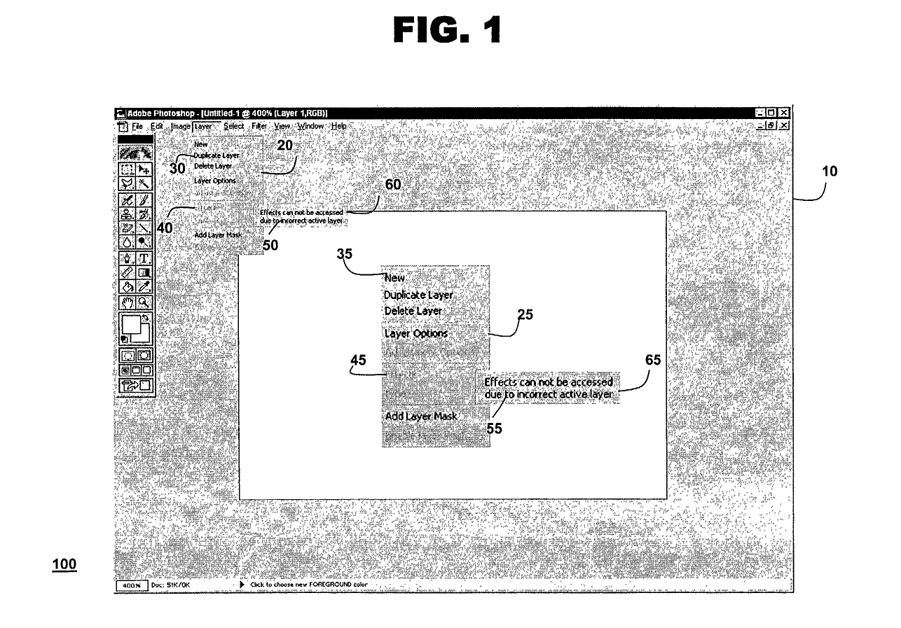

FIG. 1 shows one embodiment of a graphic user interface that provides explanatory text to accompany a disabled action in accordance with the present invention at 100. Graphic user interface may comprise, for example a “window” or screen 10. On screen 10 there can be one or more menus 20, 25. These menus may be pop up menus or drop down menus as is well known in the art. These menus may also be any suitable menus offering choices of actions to a user. When a user selects a given menu 20, 25 the menu may show enabled actions 30, 35. The menu may also show disabled actions 40, 45. A graphic user interface 100 of the present invention may also include a flyover text 50, 55 to accompany a disable action. Optionally, the flyover text 50 may be contained in a flyover window 60, 65. Alternatively, in one embodiment of the invention (not shown), the flyover text 50, 55 may also accompany enabled actions. In one embodiment of the invention, flyover window 60, 65 may appear when a user indicates a disabled action 40, 45. For example, the user may indicate the disabled action by placing a cursor over the disabled action 40, 45.

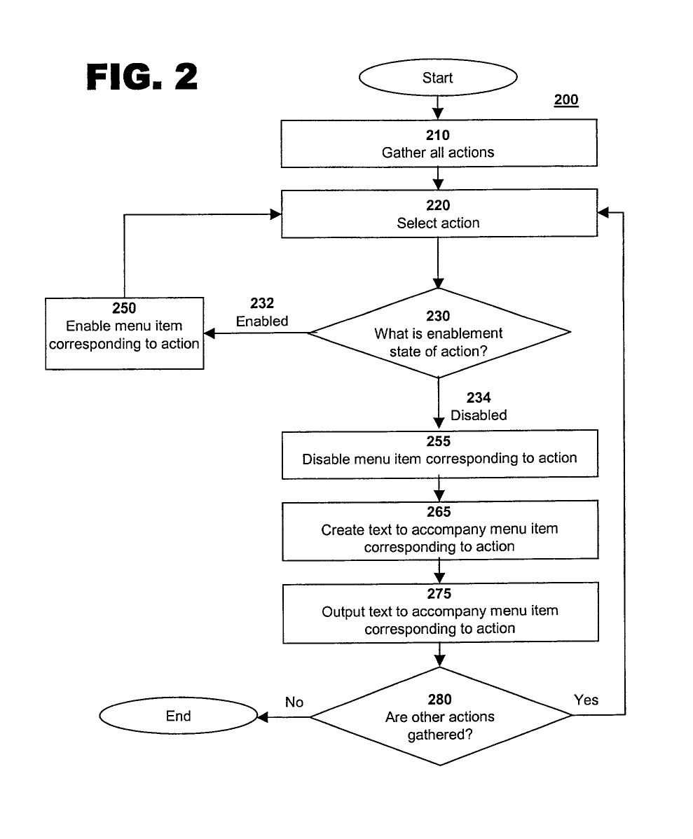

FIG. 2 shows a flow diagram of one embodiment of a process for providing explanatory text to accompany a disabled action in a graphic user interface at 200.

At block 210, all the actions may be gathered for the menu. Typically, the actions gathered may be those that will be offered as choices on a menu. In one embodiment of the invention, the actions may be actions available to be used within a given application, such as a word processing program or graphic design program. For example, the actions gathered for the menus 20, 25 are: “NEW”, “DUPLICATE LAYER”, “DELETE LAYER”, “LAYER OPTIONS”, “ADJUSTMENT OPTIONS”, “EFFECTS”, “TYPE”, “ADD LAYER MASK” and “ENABLE LAYER MASK.” Each action may comprise computer usable program product, such as, for example, computer program code that may be executed to cause the action to occur.

At block 220, one particular action may be selected for evaluation in accordance with the present invention. This action may be any of the actions gathered at block 210 above. In one embodiment of the invention, each of the actions gathered at block 210 will eventually be selected in any suitable order. Each of the actions gathered at block 210 may be selected one at a time. Alternatively, the actions may be simultaneously or nearly simultaneously processed during the routine shown at 200.

At block 230, the enablement state of the action selected at 220 is checked. For example, the enablement state of the action may be checked by determining if the action implements an interface, does not implement an interface or provides a separate object that implements an interface. The action's behavior with regard to the interface may be determined by the action itself.

For example, the action may be program code and within that code may be included whether or not to implement an interface. The interface may be, for example, a JAVA™ interface which indicates that the action is able to handle optional disabling. In one embodiment of the invention, the interface is created by a JAVA™ command that may be represented as:

Checker checker=(Checker) Class.forName (“DUPLICATE LAYER”).newInstance( )

The above command creates an interface called “Checker” and within the interface creates an array called “checker”. This interface is created in a location, for example a location within a processor running a given application called “(Checker)”. Within the location “(Checker)” an instance of an action “(DUPLICATE LAYER)” within the application. In the above example, the action “DUPLICATE LAYER” may be replaced by any suitable action. For example, the action may also be the action selected at block 220 or any of the actions gathered at 210.

Within the interface “Checker” may be a command to which the action may respond and which may indicate the enablement state of the action. In one embodiment of the invention, this may be a JAVA™ command that may be represented as:

String text=Checker.getPopupToolTipText( );

If the action does not implement the interface, the enablement state of the action may be determined to be enabled as seen at 232. The action may indicate its enablement state is enabled in any suitable manner. For example, the action may respond to the above JAVA™ string text command by returning a null string value. This null string value may indicate that the action is enabled. In one embodiment of the invention, if the action answers that it is enabled, the action may then be enabled for use. Additionally, the menu item corresponding to the action may also be enabled on the menu or formatted on the menu to indicate that the action is enabled (as seen at block 250). A new action may then be selected at block 220 for evaluation.

If the action implements the interface or provides a separate object that implements the interface, the enablement state of the action may be determined as disabled as seen at 234. The action may indicate its enablement state is disabled in any suitable manner. For example, the action may respond to the above JAVA™ string text command by returning a string value other than null. This string value may indicate that the action is disabled. In one embodiment of the invention, if the action answers that it is disabled, the action may then be disabled for use. Additionally, the menu item corresponding to the action may also be disabled on the menu or formatted on the menu to indicate that the action is disabled (as seen at block 255).

As seen at block 265 if the action answers that it is not enabled, a text may be created to accompany the disabled action as seen at block 265. In one embodiment of the invention, a flyover text is created which accompanies the menu item corresponding to the action. This flyover text may be output to the user to indicate to the user why the action is disabled (block 275). For example, the flyover text may be output in flyover window 60, 65.

At block 280, the process may determine if other actions have been gathered for evaluation. These other actions may include, for example, any of the actions gathered at block 210. The process may then be repeated for one or more of these actions. Alternatively, if no further actions have been gathered, the process may end. In one embodiment of the invention, routine 200 is repeated for every action gathered at 210.

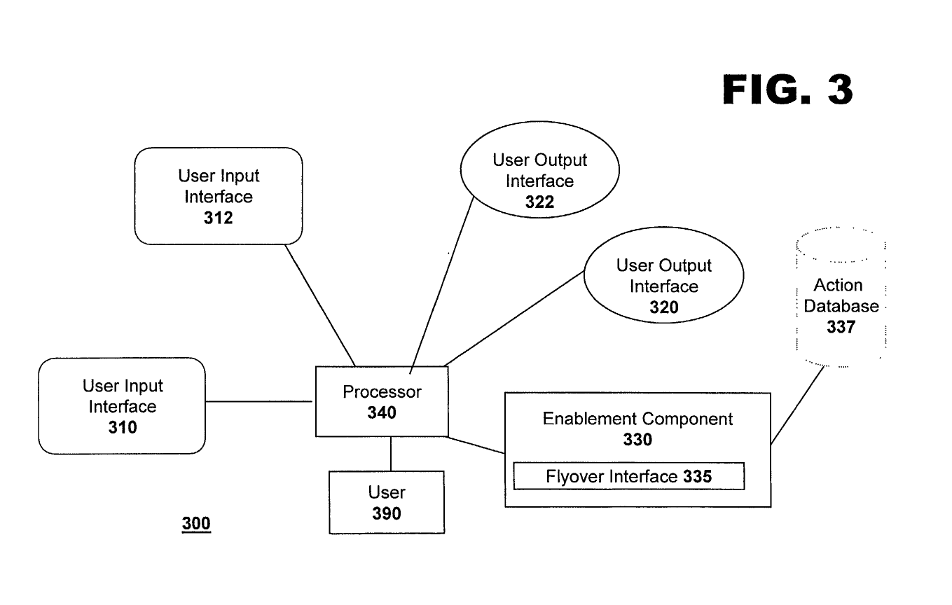

The enablement state determined at block 330 may also be determined using any other suitable method. For example, the enablement state of an action selected at 220 may be determined by comparing the action against a table or database of actions, such as action database 337 as further described in FIG. 3. The table of actions may contain a list of actions and their enablement state in a given circumstance. Any suitable means to look up the action in the table of actions and then determine its enablement state may be used, for example, program code that compares an action against the table may be used.

FIG. 3 shows one embodiment of a system for providing explanatory text to accompany a disabled action in a graphic user interface in accordance with the present invention at 300. System 300 may include, for example, a user input interface 310, 312. System 300 may also include a user output interface 320, 322. System 300 may also include an enablement component 330 which may further include a flyover interface 335. System 300 may also include a processor 340 that coordinates input or output from the interfaces 310, 320 and 335. Input may be received from or output sent to user 390. In one embodiment of the invention, input interface 310, 312, output interface 320, 322 and enablement interface 330 are graphic user interfaces or components of a graphic user interface. Processor 340 may also communicate with enablement component 330 to determine if an action is enabled or disabled. System 300 may also include an action database 337 which may include a list of actions, the enablement state of these actions and explanations for the enablement state of these actions.

System 300 may include an enablement component 330. This enablement component 330 may be any suitable computer usable program product or program component that allows processor 340 to verify if an action is enabled or disabled. In one embodiment of the invention, the enablement component 330 is a Java™ interface that may be implemented by an action. If the action implements the interface, it can be determined if the action is enabled or disabled.

The enablement component 330 may also be a component of or a component created in other suitable computer programs such as Smalltalk or C⁺⁺. For example, enablement component 330 may be a program that compares the action being verified against a database of actions 337 to determine if the action is enabled or disabled. Action database 337 may include a table of any suitable actions available to processor 340. In one embodiment of the invention, the action database 337 may include only the actions being gathered to be presented in a menu. Action database 337 may also include information about each action, including but not limited to, if the action is enabled or disabled, parameters within which the action is enabled or disabled and text to explain why an action is enabled or disabled.

In one embodiment of the invention, processor 340 verifies the enablement state of the action, e.g., if the action is enabled or disabled, using enablement component 330. Once the enablement state has been verified, processor 340 may indicate to the user 390 the enablement state of the action or may provide information regarding the enablement state of the action. In one embodiment of the invention, processor 340 may use flyover interface 335 to provide this information to the user 390. Flyover interface 335 may be any suitable interface for providing information to the user 390. Flyover interface 335 may be for example, a speaker to provide voice and other audible output to the user 390, or a visual display device such as a liquid crystal display or a cathode ray tube to provide graphical and/or textual information to the user 390. Flyover interface 335 may be a graphic user interface such as a drop-down menu, popup menu, window or graphic screen. In one embodiment of the invention, flyover interface 335 may be a window 60, 65 as described above. Flyover interface 335 may contain explanatory text that appears to on screen 10 as described above. Flyover interface 335 may appear, for example, when a cursor rests on a disabled action 40, 45.

Processor 340 may be any suitable processor for processing input from user-input interfaces 310, 312, from enablement component 330, from flyover interface 335 or from action database 337. Processor 340 may also process output for user-output interfaces 320, 322, for enablement component 330, for flyover interface 335 or for action database 337. Processor 340 may, for example, receive user input regarding a particular action from a user-input interface 310, 312. Then processor 340 may determine that the action is currently not enabled, for example, because that action will cause an error to processor 340. Processor 340 may determine if an action is enabled or disabled of an action using enablement component 330. Processor 340 may also determine the enablement state of the action using information from action database 337. Processor 340 may also prepare output to the user via user-output interface 320, 322. Such output may be, for example, a drop-down menu with the disabled action in gray. Processor 340 may also prepare output to the user. In one embodiment of the invention, processor 340 may provide output to the user via flyover interface 335. Such output may take the form of a flyover text window explaining to the user why the action is unavailable (e.g. “More than one layer must exist in the document before ‘DELETE CURRENT LAYER’ can be selected.”)

System 300 may also include user-input interfaces 310, 312 and/or user-output interfaces 320, 322. The user-input interfaces 310, 312 may receive input from the user 390 and the user-output interfaces 320, 322 may provide output to the user 390.

The user-input interfaces 310, 312 can include, but are not limited to, an electroacoustic transducer, such as, for example, a microphone to receive voice and other audible input from the user 390 or a keypad or a keyboard to receive keystrokes from the user 390. User input interfaces 310, 312 may also be touch-sensitive surface, such as a touchpad or touchscreen to receive touch input from the user 390. User input interfaces 310, 312 may also be a handwriting recognition interface to receive handwritten input from user 390 or a pointing device such as a mouse or a trackball to receive point and click inputs from the user 390. In one embodiment of the invention, user-input interface 310, 312 is a graphic user interface such as a drop-down menu, popup menu, window or graphic screen.

The user-output interfaces 320, 322 can include, but are not limited to, an electroacoustic transducer such as, for example, a speaker to provide voice and other audible output to the user 390, and a visual display device such as a liquid crystal display or a cathode ray tube to provide graphical and/or textual information to the user 390. In one embodiment of the invention, user-output interface 320, 322 is a graphic user interface such as a drop-down menu, popup menu, window or graphic screen.

System 300 may include more than one user-input interface 310, 312 or more than one user-output interface 320, 322. Moreover, the user may use one or more user-input interfaces 310, 312 or user-output interfaces 320, 322 simultaneously. For example, a personal computer may include a keyboard, a microphone, a telephone keypad, a speaker, and a visual display device.

While the present invention has been described in the context of a fully functioning graphic user interface, it will be appreciated that the processes described apply in any other suitable context. The present invention applies equally regardless of the type of signal bearing media actually used to carry out the process. Examples of computer readable media include recordable-type medium, such as a floppy disk, a hard disk drive, a RAM, CD-ROMs, DVD-ROMS, and transmission-type media, such as digital and analog communications links, wired or wireless communications links using transmission forms such as, for example, radio frequency and light wave transmissions.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

We claim:

1. A method for providing explanatory text in a graphic user interface comprising;
selecting an action to be included in the graphic user interface;
determining if the action is in a disabled state; and
providing explanatory text in the graphic user interface for the action in the disabled state.

2. The method of claim 1 further comprising:
disabling the action.

3. The method of claim 1 further comprising:
gathering a plurality of actions.

4. The method of claim 1 further comprising:
determining if the action is in an enabled state; and
providing explanatory text in the graphic user interface for the action in an enabled state.

5. The method of claim 4 further comprising:
enabling the action.

6. The method of claim 1 further comprising:
generating explanatory text that explains why the action is in the disabled state.

7. A method for providing explanatory text to a user, comprising:
gathering a plurality of actions;
selecting an evaluated action from the plurality of actions;
determining an enablement state of the evaluated action; and
providing explanatory text to the user based on the enablement state of the evaluated action.

8. The method of claim 7 further comprising:
determining if the evaluated action implements an interface.

9. The method of claim 8 wherein the evaluated action does not implement the interface, further comprising:
enabling the evaluated action; and
indicating to the user that the evaluated action is enabled.

10. The method of claim 7 wherein the evaluated action implements the interface, further comprising;
disabling the evaluated action; and
indicating to the user that the evaluated action is disabled.

11. The method of claim 7 wherein the evaluated action provides a separate object to implement the interface, further comprising:
disabling the evaluated action; and
indicating to the user that the evaluated action is disabled.

12. The method of claim 7 further comprising:
selecting a subsequent action from the plurality of actions;
determining an enablement state of the subsequent action; and
providing explanatory text to the user based on the enablement state of the subsequent action.

13. The method of claim 7 further comprising
providing an enablement list of actions and corresponding enablement states; and
comparing the evaluated action to the enablement list.

14. Computer program product in a computer usable medium for providing explanatory text to a user, comprising:
computer program code that gathers a plurality of actions;
computer program code that selects an evaluated action from the plurality of actions;
computer program code that determines an enablement state of the evaluated action; and
computer program code that provides explanatory text to the user based on the enablement state of the evaluated action.

15. The program of claim 14 further comprising:
computer program code that determines if the evaluated action implements an interface.

16. The program of claim 14, further comprising:
computer program code that disables the evaluated action; and
computer program code that indicates to the user that the evaluated action is disabled.

17. The program of claim 14 further comprising:
computer program code that selects a subsequent action from the plurality of actions;
computer program code that determines an enablement state of the subsequent action; and
computer program code that provides explanatory text to the user based on the enablement state of the subsequent action.

18. The program of claim 14 further comprising
computer program code that provides an enablement list of actions and corresponding enablement states; and
computer program code that compares the evaluated action to the enablement list.

19. The program of claim 14 further comprising:
computer program code that creates the explanatory text.

20. A system for outputting information to a user, comprising:
a first output interface wherein the first output interface includes at least one disabled option, the disabled option capable of being indicated by a user; and
a second output interface wherein the second output interface appears when the disabled option is indicated by the user.

21. The system of claim 20 wherein the second output interface is a graphic user interface including text that explains why the disabled option is disabled.
